(19) United States
(12) Patent Application Publication
(10) Pub. No.: US 2010/0277334 A1
(43) Pub. Date: Nov. 4, 2010

(54) COMMUNICATION SYSTEM FOR EMERGENCY TRANSMISSIONS AND METHOD THEREOF

(75) Inventor: Ta-Lun She, Taoyuan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXCONN COMMUNICATION TECHNOLOGY CORP., Taoyuan County (TW)

(21) Appl. No.: 12/565,889

(22) Filed: Sep. 24, 2009

(30) Foreign Application Priority Data
Apr. 29, 2009 (CN) 200910301981.2

(51) Int. Cl. G08B 21/00; H04N 7/18

(52) U.S. Cl. 340/690; 348/143; 455/404.1; 348/E07.088

(57) ABSTRACT

A communication system for emergency transmissions and method thereof are disclosed. The communication system comprises a determination unit, a location detector, a message unit, and a wireless transceiver. The determination unit calculates an earthquake magnitude of an earthquake detected by a sensor, and determines whether the earthquake magnitude reaches a default threshold magnitude. The location detector acquires a coordinate of an earthquake location when the earthquake magnitude reaches the default threshold magnitude. The message unit then generates an emergency message embodying the coordinate of the earthquake location. The wireless transceiver then transmits the emergency message to at least one emergency center.

### BACKGROUND

1. Technical Field

The present disclosure relates to a communication system for emergency transmissions and a method thereof.

2. Description of Related Art

In earthquake forecasting, accuracy is difficult to achieve in accordance with current technology since causes of the earthquakes are complicated and the earthquakes occur abruptly. Previously, such forecast has been based on scientific theory combined with experience. It is known that the first 72 hours after a violent earthquake are the most important for rescue of survivors. To the rescue workers, accurate location of such survivors is critical for successful rescue thereof.

### BRIEF DESCRIPTION OF THE DRAWINGS

FIG. 1 is a block diagram of one embodiment of a communication system for emergency transmissions.

FIG. 2 illustrates an operating environment of an electronic device executing the communication system in FIG. 1.

FIG. 3 is a flowchart illustrating one embodiment of a method for emergency transmissions.

### DETAILED DESCRIPTION

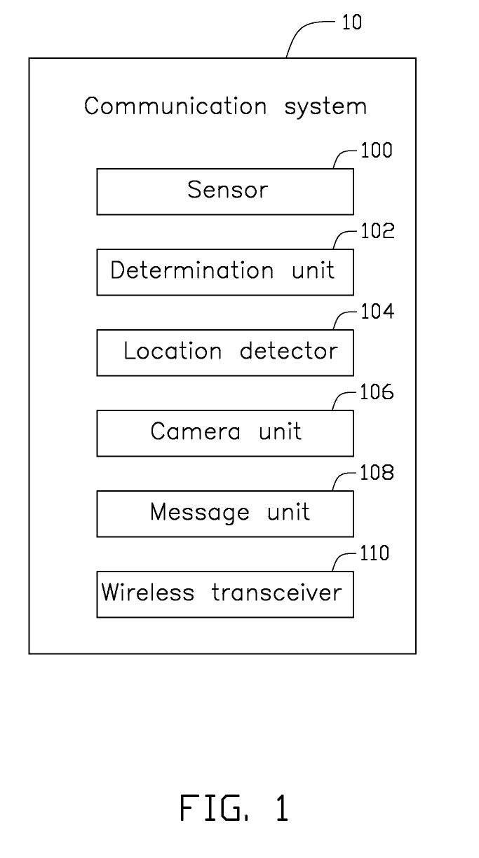

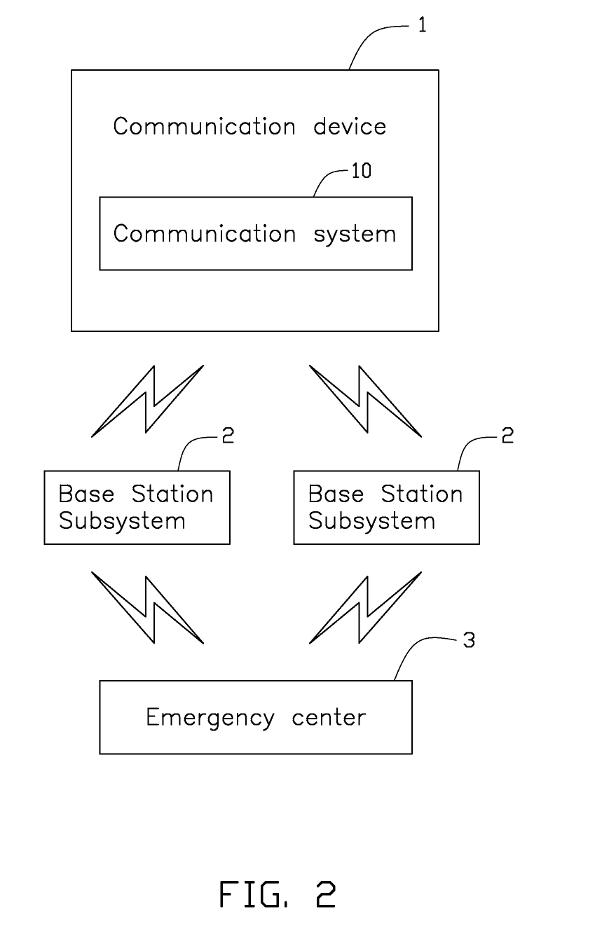

FIG. 1 is a block diagram of one embodiment of a communication system 10 for emergency transmissions. The communication system 10 includes a sensor 100, a determination unit 102, a location detector 104, a camera unit 106, a message unit 108, and a wireless transceiver 110. The communication system 10 may be used to automatically transmit an emergency message to emergency centers (e.g., a hospital) when triggered by the occurrence of a certain situation happening. In the embodiment, the situation may be a violent earthquake. FIG. 2 illustrates an operating environment of an electronic device 1 executing the communication system 10.

In general, the word “unit” as used herein, refers to logic embodied in hardware or firmware, or to a collection of software instructions, written in a programming language, such as, for example, Java, C, or assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as either software and/or hardware unit and may be stored in any type of computer-readable medium or other computer storage device.

The electronic device 1 is generally controlled and coordinated by operating system software, such as UNIX, Linux, Windows, Mac OS, an integrated operating system, or any other compatible operating systems. In other embodiments, the electronic device 1 may be controlled by a proprietary operating system. Conventional operating systems control and schedule computer processes for execution, perform memory management, provide file system, networking, and I/O services, and provide a user interface, such as a graphical user interface (GUI), among other things.

The determination unit 102 is operable to calculate the magnitude of the earthquake detected by the sensor 100 and to determine whether the earthquake magnitude reaches a default threshold magnitude. The default threshold magnitude is pre-stored in the determination unit 102. If the determination unit 102 determines that the earthquake magnitude reaches the default threshold magnitude, the determination unit 102 transmits signals to activate the location detector 104 and the camera unit 106.

In the embodiment, the location detector 104 uses an assisted global positioning system (AGPS) to acquire a coordinate of the location of the earthquake (hereinafter, “the earthquake location”) from Base Station Subsystems (BSSs) 2 when the earthquake magnitude reaches the default threshold magnitude. After acquiring the coordinate of the earthquake location, the location detector 104 transmits the coordinate to the camera unit 106.

The camera unit 106 captures an image of the earthquake location when the earthquake magnitude reaches the default threshold magnitude. After capturing the image, the camera unit 106 integrates the coordinate of the earthquake location into an Exchange image file format (EXIF) of the captured image and then sends the captured image to the message unit 108.

The message unit 108 is configured for generating the emergency message embodying the captured image from the camera unit 106. The wireless transceiver 110 then transmits the emergency message to an emergency center 3. The emergency message further includes pre-stored text for requesting assistance and may be transmitted via Short Message Service (SMS), Multimedia Messaging Service (MMS), or other.

As shown in FIG. 2, the electronic device 1 includes the communication system 10. When a earthquake occurs, the electronic device 1 senses the earthquake. The determination unit 102 of the communication system 10 calculates the earthquake magnitude of the earthquake and determines if the earthquake magnitude reaches the default threshold magnitude. The determination unit 102 transmits the signals to direct the location detector 104 to acquire the coordinate of earthquake location from the BSSs 2. The electronic device 1 then transmits the emergency message embodying the coordinate of the earthquake location to the emergency center 3 by the BSSs 2.

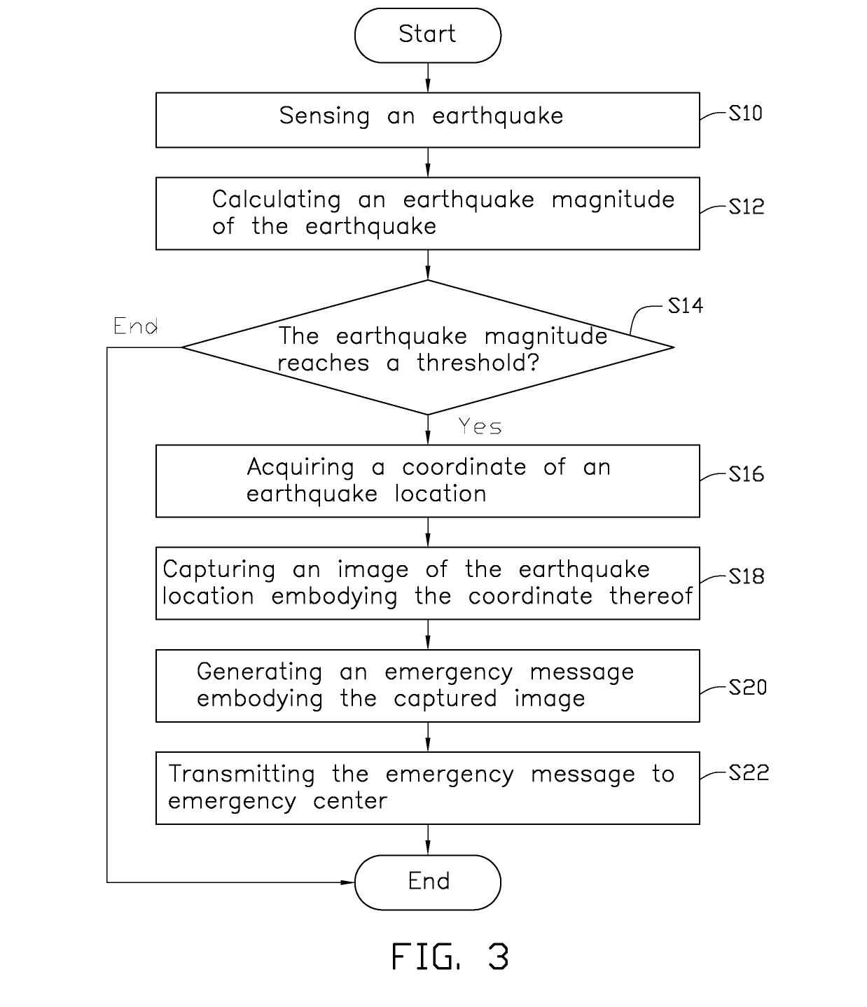

FIG. 3 is a flowchart illustrating one embodiment of a method for emergency transmissions, applicable in, for example, the communication system 10. Depending on the embodiment, additional blocks in the flow of FIG. 3 may be added, others removed, and the ordering of the blocks may be changed.

If an earthquake occurs, in block S10, the sensor 100 senses the earthquake.

In block S12, the determination unit 102 calculates the earthquake magnitude of the earthquake.

In block S14, the determination unit 102 determines whether the earthquake magnitude reaches a default threshold magnitude. If the earthquake magnitude does not reach the default threshold magnitude, the process is complete.

If the earthquake magnitude reaches the default threshold magnitude, in block S16, the location detector 104 acquires the coordinate of the earthquake location from the BSSs 2.

In block S18, the camera unit 106 captures an image of the earthquake location. After capturing the image, the camera unit 106 integrates the coordinate of earthquake location into the Exchange image file format (EXIF) of the captured image and then sends the captured image to the message unit 108.

In block S20, the message unit 108 generates an emergency message embodying the captured image.

In block S22, the wireless transceiver 110 transmits the emergency message to the emergency center 3, and the process is complete.

The communication system and the method of the present disclosure automatically transmit an emergency message embodying the captured image and the coordinate of the earthquake location to emergency centers when a violent earthquake occurs. If buildings located at the earthquake location collapse, rescue workers can more rapidly and efficiently rescue survivors sank under the collapsed buildings in accordance with the emergency message enabled by the system and method of the disclosure.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A communication system for emergency transmissions, comprising:
a determination unit to calculate an earthquake magnitude of an earthquake detected by a sensor of the communication system, and to determine whether the earthquake magnitude reaches a default threshold magnitude;
a location detector to acquire a coordinate of an earthquake location of the earthquake;
a message unit to generate an emergency message embodying the coordinate of the earthquake location; and
a wireless transceiver to transmit the emergency message to at least one emergency center if the earthquake magnitude reaches the default threshold magnitude.

2. The communication system of claim 1, further comprises a camera unit to capture an image of the earthquake location.

3. The communication system of claim 2, wherein the coordinate of earthquake location is integrated into an Exchange image file format (EXIF) of the captured image.

4. The communication system of claim 3, wherein the emergency message is further integrated with the captured image.

5. A computer-implemented method for emergency transmissions comprising:
sensing an earthquake using a sensor and calculating an earthquake magnitude of the earthquake;
determining whether the earthquake magnitude reaches a default threshold magnitude;
acquiring a coordinate of an earthquake location of the earthquake;
generating an emergency message embodying the coordinate of the earthquake location; and
transmitting the emergency message to at least one emergency center.

6. The method of claim 5 further comprising:
capturing an image of the earthquake location.

7. The method of claim 6 further comprising:
integrating the coordinate of the earthquake location into an Exchange image file format (EXIF) of the captured image.

8. The method of claim 7 further comprising:
integrating the captured image with the coordinate of the earthquake location into the emergency message.

9. A storage medium having stored thereon instructions that, when executed by a processor, cause the processor to perform a method for emergency transmissions, the method comprising:
sense an earthquake using a sensor and calculating an earthquake magnitude of the earthquake;
determine whether the earthquake magnitude reaches a default threshold magnitude;
acquire a coordinate of an earthquake location of the earthquake;
generate an emergency message embodying the coordinate of the earthquake location; and
transmit the emergency message to at least one emergency center.

10. The storage medium of claim 9, wherein the method further comprising:
capture an image of the earthquake location.

11. The storage medium of claim 10, wherein the method further comprising:
integrate the coordinate of the earthquake location into an Exchange image file format (EXIF) of the captured image.

12. The storage medium of claim 11, wherein the method further comprising:
integrate the captured image with the coordinate of the earthquake location into the emergency message.
